(19) United States
(12) Patent Application Publication
(10) Pub. No.: US 2014/0310687 A1
(43) Pub. Date: Oct. 16, 2014

(54) DATABASE SERVER AND PROGRAM PACKAGE INTEGRATING METHOD

(71) Applicants: HON HAI PRECISION INDUSTRY CO., LTD., New Taipei (TW); Fu Tai Hua Industry (Shenzhen) Co., Ltd., Shenzhen (CN)

(72) Inventors: QI-DI WU, Shenzhen (CN); YAO-HUA LIU, Shenzhen (CN); XIAO-SONG LIU, Shenzhen (CN); XI LIN, Shenzhen (CN); YUN-YAN WU, Shenzhen (CN); RONG-RONG PENG, Shenzhen (CN); XIAN-YANG QU, Shenzhen (CN); XIN LU, Shenzhen (CN); SHIH-FANG WONG, New Taipei (TW)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 14/191,457

(22) Filed: Feb. 27, 2014

(30) Foreign Application Priority Data
Apr. 15, 2013 (CN) 2013101271542

(51) Int. Cl. G06F 9/44

(52) U.S. Cl. CPC G06F 8/71
USPC 717/121

(57) ABSTRACT

A database server communicates with a plurality of client devices. Each of the client devices is used to create a program package to cooperatively develop a software project. An integrating package is created in a storage of the database server. When two or more client devices simultaneously access the integrating package, a storage region is created for each of the two or more client devices in a storage space of the integrating package. When the two or more client devices write the program package to the integrating package, the program package of each of the two or more client devices is automatically written into a corresponding storage region.

### BACKGROUND

1. Technical Field

Embodiments of the present disclosure relate to software program developments, and particularly to, a database server and a program package integrating method.

2. Description of Related Art

During development of a software project, a plurality of software program modules may be produced. Each module may include a plurality of procedural elements and/or functions. These procedural elements and functions may be located together in the same directory. Maintaining these procedural elements and functions is inconvenient. In order to modularize software programs, the procedural language/structured query language (PL/SQL®) defines a “package” to manage the procedures and functions. When a large software project is developed by multiple developers, a package is created by each developer to cooperatively develop programs of the software project. When the development of the software project is accomplished, the package created by each developer needs to be integrated in an integrating package.

If the packages of two or more developers are integrated in the integrating package at the same time, programs of the other package may overwrite some of the programs of one package. Therefore, there is room for improvement in the art.

### BRIEF DESCRIPTION OF THE DRAWINGS

FIG. 1 is a schematic block diagram illustrating one embodiment of a database server communicating with a plurality of client devices.

FIG. 2 is a schematic block diagram illustrating one embodiment of functional modules of the database server of FIG. 1.

FIG. 3 is a flowchart of one embodiment of a method for integrating program packages of a software project using the functional modules of the database server of FIG. 2.

FIG. 4 shows a schematic view of storage space of an integrating package.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

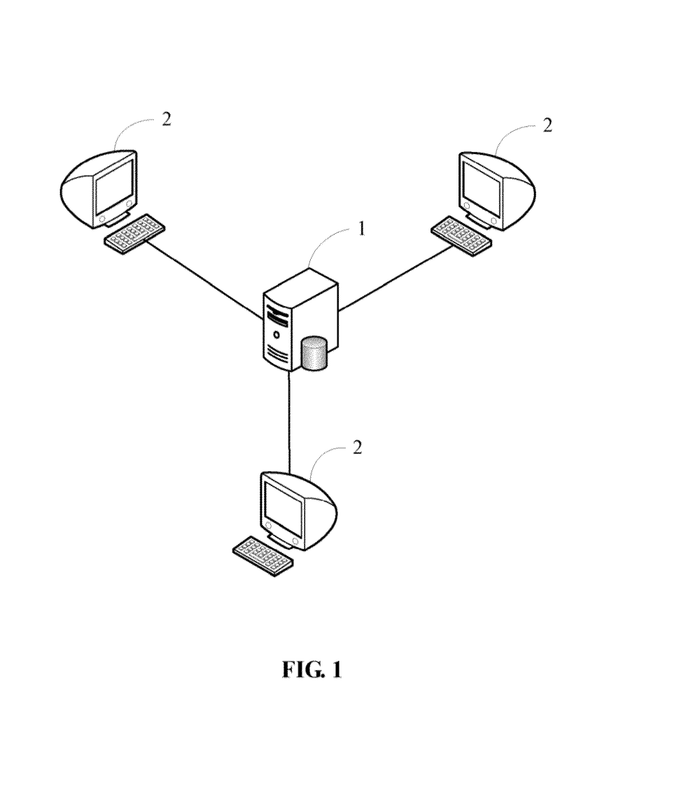

FIG. 1 is a schematic block diagram illustrating one embodiment of a database server 1 communicating with a plurality of client devices 2. The client devices 2 can be personal computers. The database server 1 can communicate with the client devices 2 via a communication network, such as a local area network (LAN) or Internet. Two or more users can each use a client device 2 to create a program package to cooperatively develop a software project. When the program package of each user is completed, each created program package is integrated to the database server 1, to complete the software project.

In this embodiment, the program package refers to an ORACLE® package. The database server 1 can be a structured query language (SQL) server.

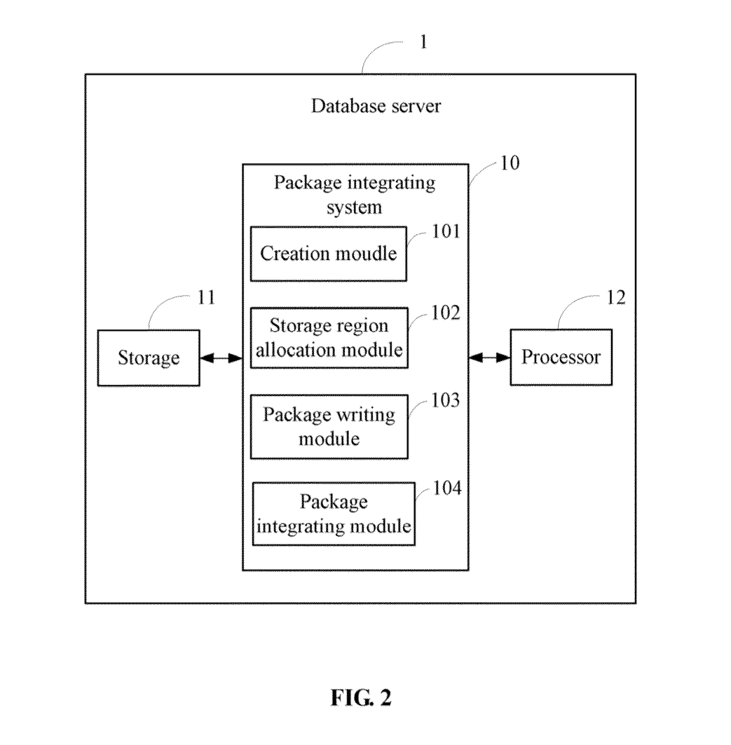

FIG. 2 is a schematic block diagram illustrating one embodiment of functional modules of the database server 1 of FIG. 1. The database server 1 includes a package integrating system 10, a storage 11, and a processor 12. The program integrating system 10 can include a plurality of programs in the form of one or more computerized instructions stored in the storage 11 and executed by the processor 12 to perform operations of the database server 1. In the embodiment, the program integrating system 10 includes a creation module 101, a storage region allocation module 102, a package writing module 103, and a package integrating module 104. The storage 11 can be an external or embedded storage medium of the database server 1, such as a hard disk drive (HDD).

In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

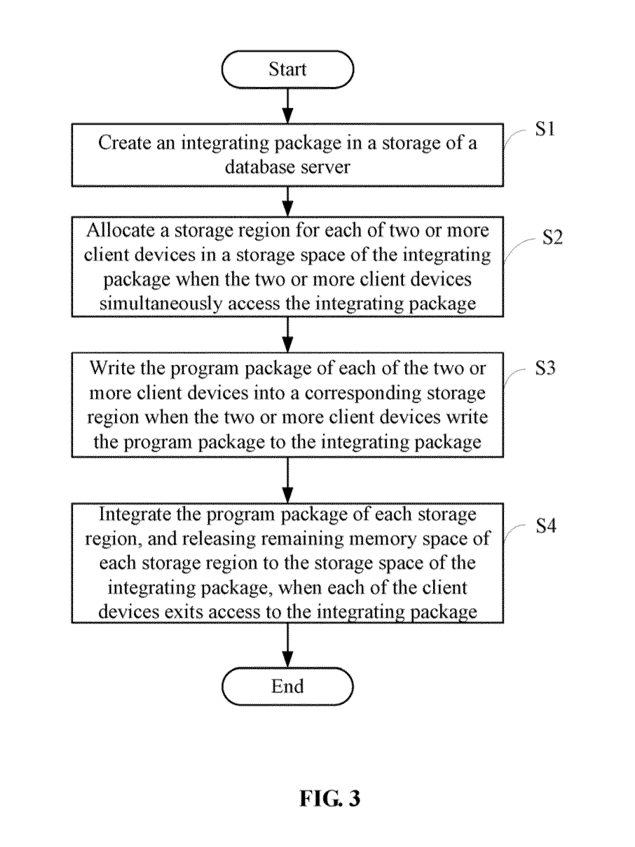

FIG. 3 is a flowchart of one embodiment of a method for integrating program packages of a software project using the functional modules of the database server 1 of FIG. 2. Depending on the embodiment, additional steps may be added, others removed, and the ordering of the steps may be changed.

In step S1, the creation module 101 creates an integrating package in the storage 11 of the database server 1, to store the program package created by each client device 2. In this embodiment, the integrating package can be a directory having a certain storage space created in the storage 11.

In step S2, the storage region allocation module 102 allocates a storage region for each of two or more client devices 2 in the storage space of the integrating package when the two or more client devices 2 simultaneously access the integrating package.

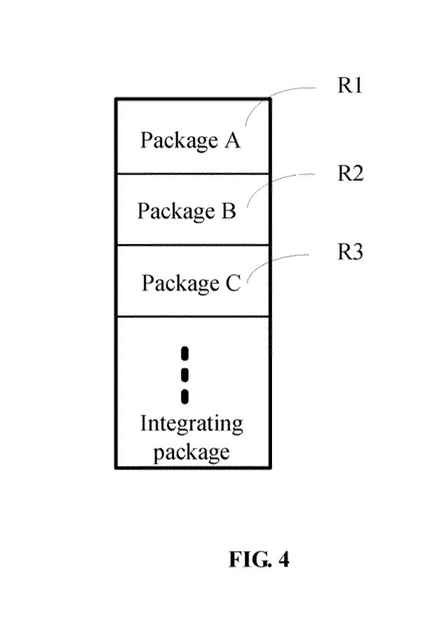

FIG. 4 shows in one example, when three client devices 2, such as client devices A, B, and C simultaneously access the integrating package, the storage region allocation module 102 respectively allocates storage regions R1, R2, R3 for the client devices A, B, C. Thus, the program package stores packages A, B, C, created by each of the client devices 2.

In step S3, when the two or more client devices 2 write the program package to the integrating package, the package writing module 103 writes the program package of each of the two or more client devices 2 into a corresponding storage region which is allocated for each of the two or more client devices 2.

In one embodiment, the storage region allocated for each client device 2 is invisible to the user of the client device 2. In other embodiments, the storage region allocated for each client device 2 is visible to the user of the client device 2. If the storage region is visible to the user, the user using a corresponding client device 2 can operate in the storage region, and the program package of the corresponding client device 2 can be manually written directly into the storage region. If the storage region is invisible to the user, the user can only operate the integrating package directly, and the program package of different client devices 2 is automatically written into a corresponding storage region by the package writing module 103, thereby avoiding programs from different program package from being overwritten with each other.

In step S4, when each of the client devices 2 exits access to the integrating package, the package integrating module 104 integrates the program package of each storage region, such as storing the program package of each storage region in the storage address of the integrating package in sequence. The remaining memory space of each storage region is released to the storage space of the package integrating module 104.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A program package integrating method implemented by a database server communicating with a plurality of client devices, each of the client devices being used to create a program package to cooperatively develop a software project, the method comprising:
creating an integrating package in a storage of the database server;
allocating a storage region for each of two or more client devices in a storage space of the integrating package when the two or more client devices simultaneously access the integrating package; and
writing the program package of each of the two or more client devices into a corresponding storage region allocated for each of the two or more client devices, when the two or more client devices write the program package to the integrating package.

2. The method according to claim 1, further comprising integrating the program package of each storage region, and releasing remaining memory space of each storage region to the storage space of the integrating package, when each of the client devices exits access to the integrating package.

3. The method according to claim 2, wherein the program package of each storage region is integrated by storing the program package of each storage region in a storage address of the integrating package in sequence.

4. The method according to claim 1, wherein the integrating package is a directory having a storage space created in the storage of the database server.

5. The method according to claim 1, wherein the database server is a structured query language (SQL) server.

6. The method according to claim 1, wherein the storage region allocated for each client device is invisible to a user of the client device.

7. The method according to claim 1, wherein the storage region allocated for each client device is visible to a user of the client device.

8. A database server communicating with a plurality of client devices, each of the client devices being used to create a program package to cooperatively develop a software project, the database server comprising:
a storage;
a processor; and
one or more programs executed by the processor to perform a program package integrating method, the program package integrating method comprising:
creating an integrating package in the storage of the database server;
allocating a storage region for each of two or more client devices in a storage space of the integrating package when the two or more client devices simultaneously access the integrating package; and
writing the program package of each of the two or more client devices into a corresponding storage region allocated for each of the two or more client devices, when the two or more client devices write the program package to the integrating package.

9. The database server according to claim 8, wherein the method further comprises integrating the program package of each storage region, and releasing remaining memory space of each storage region to the storage space of the integrating package, when each of the client devices exits access to the integrating package.

10. The database server according to claim 9, wherein the program package of each storage region is integrated by storing the program package of each storage region in a storage address of the integrating package in sequence.

11. The database server according to claim 8, wherein the integrating package is a directory having a storage space created in the storage of the database server.

12. The database server according to claim 8, wherein the database server is a structured query language (SQL) server.

13. The database server according to claim 8, wherein the storage region allocated for each client device is invisible to a user of the client device.

14. The database server according to claim 8, wherein the storage region allocated for each client device is visible to a user of the client device.
